(19) United States
(12) Patent Application Publication
(10) Pub. No.: US 2014/0327418 A1
(43) Pub. Date: Nov. 6, 2014

(54) Extended Current Capability for Power Sourcing Equipment

(71) Applicant: Broadcom Corporation, Irvine, CA (US)

(72) Inventor: Jian Yu, Pleasanton, CA (US)

(73) Assignee: Broadcom Corporation, Irvine, CA (US)

(21) Appl. No.: 13/893,884

(22) Filed: May 14, 2013

Related U.S. Application Data
(60) Provisional application No. 61/818,615, filed on May 2, 2013.

(51) Int. Cl. G05F 1/46

(52) U.S. Cl. CPC G05F 1/46
USPC 323/268

(57) ABSTRACT

A current mirror (e.g., an N or P channel MOSFET current mirror) is present in a load current delivery path. The current delivery path typically includes a network connection, e.g., for power over Ethernet applications. The current mirror provides a reference output, and the load current flows through a primary transistor in the current mirror from a load current input to a load current output of the primary transistor. A mirror transistor generates a sense current on the reference output that is a fractional amount of the load current. A power controller monitors the reference output and controls the current mirror to allow or prevent the load current flowing through the network connection. For example, the power controller may disable the primary transistor and the delivery of load current, when the load is demanding too much load current.

### PRIORITY CLAIM

This application claims priority to U.S. Provisional Application Ser. No. 61/818,615, filed 2 May 2013, titled “Extended Current Capability for Power Sourcing Equipment,” which is incorporated herein by reference in its entirety.

### TECHNICAL FIELD

This disclosure relates to network devices. In particular, this disclosure relates to delivery of power over network connections, including power over Ethernet.

### BACKGROUND

High speed data networks form part of the backbone of what has become indispensable worldwide data connectivity. Within the data networks, network devices such as switching devices direct data packets from source ports to destination ports, helping to eventually guide the data packets from a source to a destination. Improvements in network devices, including improvements in delivery of power over the network, will further enhance the capabilities of data networks.

### BRIEF DESCRIPTION OF THE DRAWINGS

FIG. 1 shows an example of a system using an N channel power FET and a 1:n current mirror for controlling load current to a load.

FIG. 2 is an example of a system using a P channel power FET and a 1:n current mirror for controlling load current to a load.

FIG. 3 shows an example of a system using an N channel power FET and a 1:200 current mirror for controlling load current to a load.

FIG. 4 shows an example of logic for controlling load current to a load.

### DETAILED DESCRIPTION

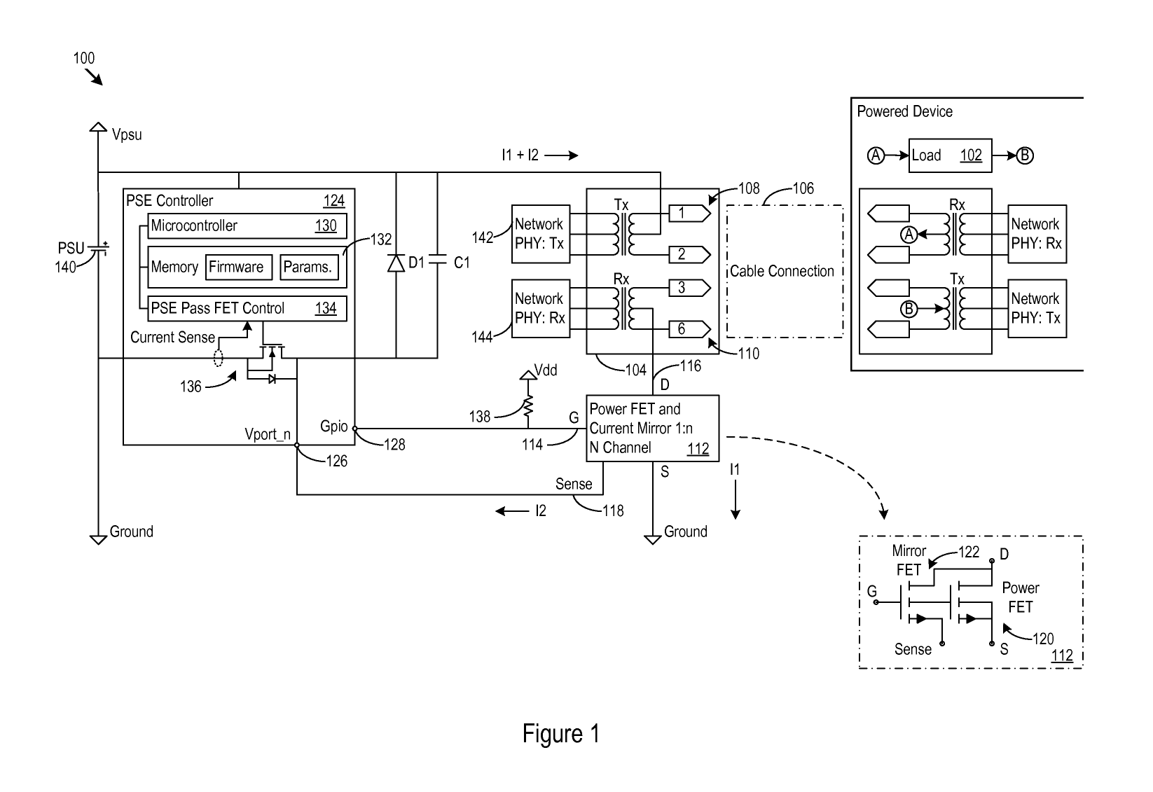

FIG. 1 shows an example of a system 100 for controlling load current to a network connected load 102. The system 100 may be included in a device that provides power, e.g., power sourcing equipment (PSE), into the network. The load 102 may be part of a device that draws power from the network, e.g., a powered device (PD). The PSE may be, as examples, an endpoint such as a network switch or router, or a midspan that provides power while passing through the data. A midspan may be used to add power delivery to an existing non-power delivery network. The load 102 may be a part of virtually any PD, such as a security camera, Internet Protocol (IP) phone, or Wireless Access Point (WAP). Virtually any device that includes a network compatible connector can connect to the network and act as the load 102.

IEEE standards define some types of power delivery over Ethernet networks. For example, IEEE 802.3af specifies a maximum allowed continuous output power (per cable) of 15.40 Watts (W) with a current limit of 350 mA. The IEEE 802.3at standard specifies 25.50 W with a current limit of 600 mA. Described below are techniques that provide a way to supply greater load current while using existing PSE controllers. The result is a cost effective, efficient mechanism for greatly increasing load current delivery capability using existing PSE controller designs.

The example system 100 in FIG. 1 includes a PSE controller 124 that controls power delivery over a network through a network connection 104. The protective diode D1 and filter capacitor C1 may be present in this or other designs. The network connection 104 may take the form an RJ45 network port into which a network cable 106 connects for attaching the load 102 to the network. As one example, the network may be an Ethernet network. The techniques described are not limited to any particular network or network connection, however. Instead, as examples, many other network connections may be used, such as RJ48, RJ61, RJ11, or other network connections for Ethernet or other types of networks.

The network connection 104 includes a transmit connection 108 (e.g., pins 1 and 2 of an Ethernet RJ45 port) and a receive connection 110 (e.g., pins 3 and 6 of an Ethernet RJ45 port). An FET current mirror 112 is connected in the load current path to the load 102. The load current is designated 11 in FIG. 1. In the example of FIG. 1, the FET current mirror 112 is connected to the network connection 104 on the low side, e.g., in the return path of the load current to the PSE.

The FET current mirror 112 includes a control input 114, a load input 116, and a reference output 118. The load input 116 receives the load current delivered through the network connection 104. In the FET current mirror 112, a primary FET transistor 120 is present through which the load current flows, and which is connected to the control input 114 and the load input 116. In addition, a mirror transistor 122 is connected in a current mirror configuration with the primary transistor 120. The mirror transistor 122 is configured to generate a sense current, labeled 12, on the reference output 118. The sense current is a preconfigured mirror ratio of the load current 11.

The mirror ratio depends on the geometry (e.g., length and width) and other physical characteristics of the mirror transistor 122 in relation to the primary transistor 120. As some examples, the mirror ratio may be 1:200, 1:250, 1:400, or another ratio 1:n. The ratio may be selected such that the sense current meets the device input requirements for any particular sense input 126 on the PSE controller 124. For example, assume a maximum desired load current of 20A and a maximum allowed input current into the sense input 126 of 600 mA. The FET current mirror 112 may be chosen to have a mirror ratio of at least 1:34 so that a 20A load current results in less than 700 mA of sense current. Using the FET current mirror 112 has the benefit of producing a sense current that is relatively small compared to the large extended load current and that can be handled by existing PSE controllers. Also, increasing the mirror ratio decreases the sense current, which may be beneficial from a power savings, thermal, or current handling standpoint.

The PSE controller 124 includes a sense input 126 in communication with the reference output 118 and also includes a control output 128 in communication with the control input 114. The sense input 126 may be the traditional negative/return port of an existing PSE controller. The PSE controller 124 may include a processor 130 (e.g., a microcontroller) in communication with a memory 132 and sense control logic 134. The memory 132 may store control instructions (e.g., firmware) executed by the processor 130, as well as parameters used by the control instructions. In particular, the parameters may include the mirror ratio implemented by the current mirror 112, and a load current limit that may for example, represent the maximum allowed load current delivered to the load 102.

In operation, the control instructions cause the PSE controller 124 to read the mirror ratio, load current limit, and any other parameters, and monitor the reference output 118 to determine load current through the network connection. To that end, the processor 130 may receive current sense readings from a current sensor in communication with the sense control logic 134, or in communication with the processor 130 directly. The sense control logic 134 may permit or disable sense current flow through the sense input 126 by configuring (e.g., via a gate voltage) the pass transistor 136. The PSE controller 124 determines how to drive the control output 128 depending on the load current. The control output 128 may be a general purpose input/output pin available on the PSE controller 124.

For example, when the load current exceeds the load current limit, the control instructions may cause the PSE controller 124 to assert a disable signal on the control output 128. The disable signal is communicated to the primary transistor 120 (and the mirror transistor 122) in the FET current mirror 112 through which the load current flows. The disable signal may be, for instance, a low gate voltage that prevents the primary transistor 120 from conducting the load current. When the primary transistor 120 is disabled, load current cannot flow, and the network port is effectively disabled.

As a specific example, assume a mirror ratio of 1:200 and a load current limit of 4 A. When the sense current exceeds 20 mA (4 A/200), then the load current has exceeded 4 A, and the PSE controller 124 may disable the primary transistor 120. The PSE controller 124 may wait to disable the primary transistor 120 until the load current has been exceeded for more than a predetermined time (e.g. for more than 1 second), and may enable the primary transistor 120 after a predetermined reset delay (e.g., 1 minute), both of which may be included as parameters in the memory 132.

As another example, when the load current does not exceed the load current limit, the control instructions may cause the PSE controller 124 to assert an enable signal on the control output 128. The enable signal is communicated to the primary transistor 120 in the FET current mirror 112 through which the load current flows. The enable signal may be, for instance, a high voltage that allows the primary transistor 120 to conduct load current. When the primary transistor 120 is enabled, load current can flow to the load 102, and the network port is effectively enabled. The primary transistor 120 (and therefore the mirror transistor 122) is normally enabled by virtue of the pullup resistor 138.

As a specific example, assume again a mirror ratio of 1:200 and a load current limit of 4 A. When the sense current is less than 20 mA (4 A/200), then the load current is less than 4 A. As a result, the PSE controller 124 keeps the primary transistor 120 enabled.

The system 100 may be used to extend the capabilities of existing PSE controllers in terms of current delivery to a load. For example, assume that the PSE controller 124 is an IEEE 802.3af compatible device. IEEE 802.3af PSEs normally limit load current to 350 mA. However, using the FET current mirror 112 to deliver a sense current to the PSE controller 124 that is a fraction of the load current, the current delivery capability is extended by the mirror ratio. For example, when the mirror ratio is 1:200, the extended current capability is 350 mA×200=70 A. Similarly, for an IEEE 802.3at compatible PSE controller 124 that limits load current to 600 mA, the extended load current capability is 600 mA×200=120 A.

The implementation of the system 100 may vary widely, depending on the desired application. As one example, the PSE controller 124 may be a Broadcom BCM59111 power over Ethernet PSE controller. The current mirror 112 may be an ON-Semiconductor NIMD6302R2 MOSFET with current mirror FET having a 1:200 mirror ratio. As another example, the current mirror may be an ON-Semiconductor NILMS4501N power MOSFET with current mirror FET having a 1:250 mirror ratio.

The power supply unit (PSU) 140 may generate, e.g., nominally 12V, 48V, or other voltage. The PSU is also designed to source the load current to meet or exceed whatever load current limit is desired for any number of powered network ports in the device (e.g., 32 A for 8 powered 4 A ports).

Note also that network physical (PHY) layers are present to send and receive data signals over the network connections 108 and 110. There may be, for example, an Ethernet PHY Tx pair layer 142 for transmitting data, and an Ethernet PHY Rx pair layer 144 for receiving data. However, as noted above, the techniques described may be used with other types of networks. Accordingly, the examples above are just a few of the many possible design implementations, and many other implementations are possible.

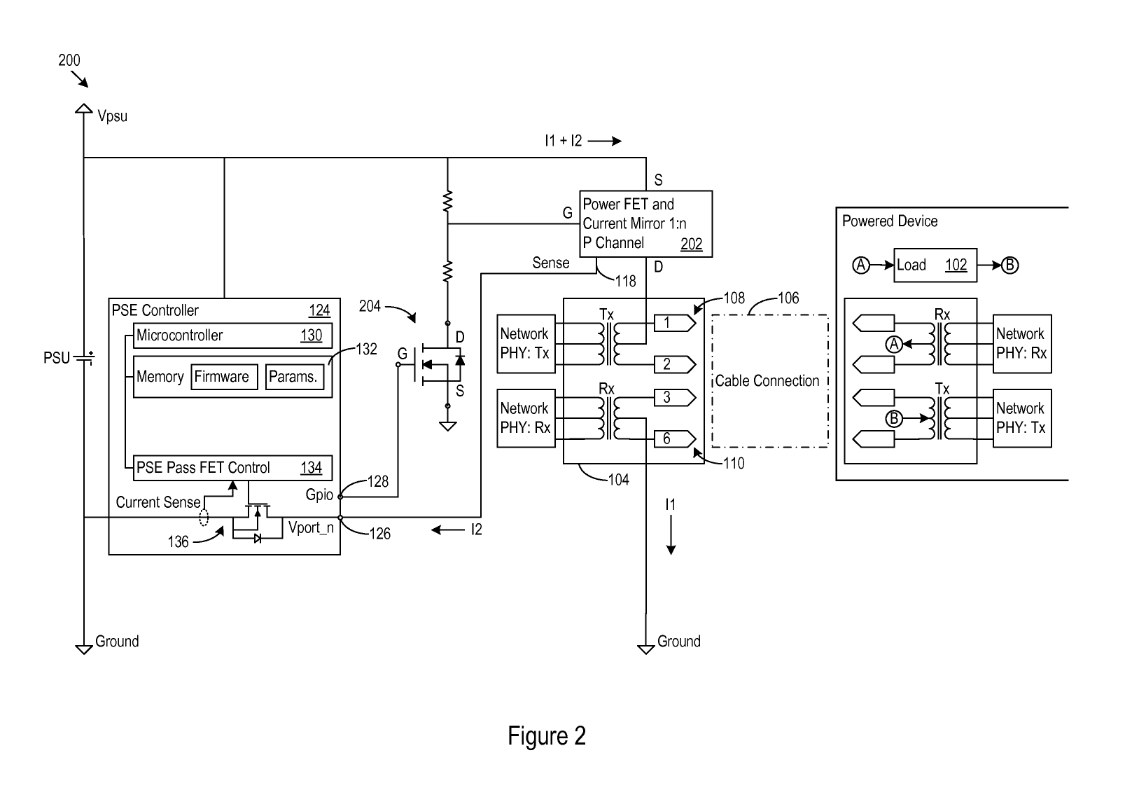

FIG. 2 is another example of a system 200 for controlling load current to a load 102. In the system 200, a P channel device current mirror 202 is present on the high side, e.g., in the outgoing current path to the load 102. In this example, the control output 128 first controls an N channel MOSFET 204. The MOSFET 204 controls the application and removal of a relatively high voltage to and from the gate of the P channel MOSFETs in the current mirror 202. The control output 128 thereby provides an enable signal and disable signal to the P channel FET current mirror 202 that is responsive to sense current measurements as explained above to enable or disable load current flow.

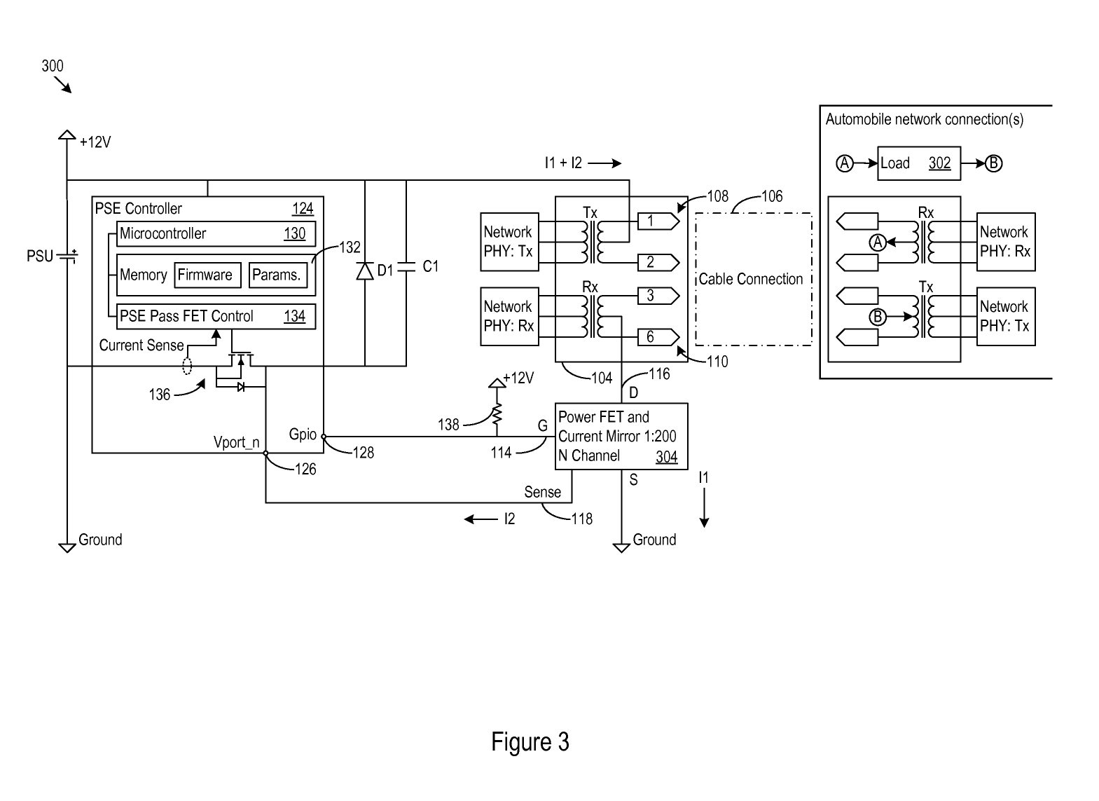

FIG. 3 shows another example of a system 300 for controlling load current to a load. In this example, the system 300 is part of a vehicle network, e.g., an automobile network for a driverless car. Accordingly, the PSU may be the battery, e.g., a 12 V battery. The load 302 may be any network attached device in the vehicle, such as an engine control module, global positioning system, climate control module, audio/video entertainment system, computer system for, e.g., computing directions and executing driverless guidance of the vehicle to a destination, or any other network attached system in the vehicle.

In this example, the load current limit is set to 4 A at 12 V. The current mirror 304 has a mirror ratio of 1:200, e.g., implemented by an ON-Semiconductor NIMD6302R2. The PSE controller 124 is configured to monitor for a sense current that exceeds 4 A/200=20 mA. To that end, the firmware in the memory 132 may determine whether the sense current exceeds 20 mA, indicating that the load current limit of 4 A has been exceeded. Note that the memory 132 may store 20 mA as the load current limit when the firmware compares directly against the sensed current, or 4 A as the load current limit when the firmware will apply the mirror ratio to the sensed current to determine the actual load current.

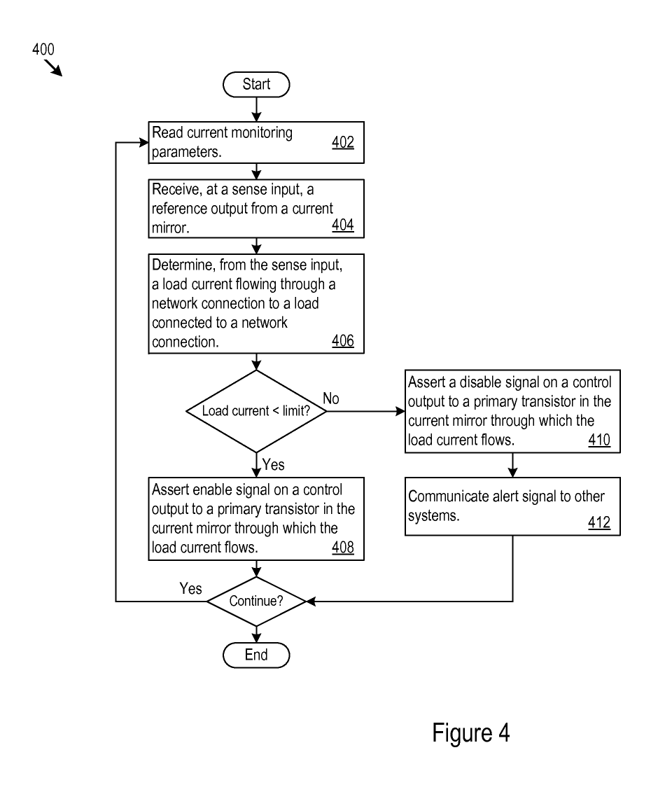

FIG. 4 shows an example of logic 400 for controlling load current to a load. The firmware in the memory 132 may implement the logic 400, for example. The logic 400 includes reading current monitoring parameters such as the load current limit and the mirror ratio that relates sense current to load current (402). Any of the parameters may change at any time, and the logic 400 may read updated parameters at any time.

The logic 400 receives, at a sense input, a reference output from a current mirror (404). The reference output may carry a sense current to the sense input, with the sense current provided by a mirror transistor matched to a primary transistor through which the load current flows in the current mirror. The logic 400 also determines, from the sense input, a load current flowing through a network connection to a load connected to the network connection (406). For example, the logic 400 may multiply a sense current measurement by the mirror ratio to determine the load current.

The logic 400 may also make load current control decisions in response to determining whether the load current complies with the load current limit. For example, when the load current is less than the load current limit, the logic 400 may assert an enable signal on the control output to the primary transistor in the current mirror through which the load current flows (408). As another example, when the load current exceeds the load current limit, then the logic 400 may assert a disable signal on the control output to the primary transistor in the current mirror through which the load current flows. The logic 400 may also issue an information signal to other systems or logic that alerts the other systems that the load current has been exceeded, e.g., to a control system in a vehicle (412).

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A system comprising:
a network connection;
a current mirror comprising:
a load input in communication with the network connection;
a control input; and
a reference output responsive to the load input; and
a network power controller comprising:
a sense input in communication with the reference output; and
a control output in communication with the control input;
the network power controller configured to:
monitor the reference output to determine load current through the network connection; and
determine how to drive the control output depending on the load current.

2. The system of claim 1, where the current mirror comprises:
a primary transistor through which the load current flows; and
a mirror transistor through configured to provide the reference output.

3. The system of claim, where the reference output is configured to provide a sense current arising from the load current on the reference output.

4. The system of claim 3, where the sense current is a predetermined ratio of the load current.

5. The system of claim 4, where the network power controller is further configured to determine the load current by measuring the sense current, and applying the predetermined ratio.

6. The system of claim 1, where the network power controller is configured to determine how to drive the control output by:
determining whether the load current exceeds a load current limit; and
when the load current exceeds the load current limit, asserting a disable signal on the control output.

7. The system of claim 1, where the network power controller is configured to determine how to drive the control output by:
determining whether the load current exceeds a load current limit; and
when the load current does not exceed the load current limit, asserting an enable signal on the control output.

8. The system of claim 1, where the current mirror further comprises:
a primary transistor through which the load current flows, the primary transistor connected to the control input.

9. A method comprising:
receiving, at a sense input, a reference output from a current mirror;
determining, from the sense input, a load current flowing through a network connection to a load connected to the network connection;
making a load current control decision in response to determining the load current.

10. The method of claim 9, where determining further comprises:
obtaining a measurement of sense current on the sense input; and
applying a predetermined ratio to the measurement to determine the load current.

11. The method of claim 9, where making a load current control decision comprises:
asserting an enable signal on a control output to the current mirror.

12. The method of claim 9, where making a load current control decision comprises:
asserting an enable signal on a control output to a primary transistor in the current mirror through which the load current flows.

13. The method of claim 9, where making a load current control decision comprises:
asserting a disable signal on a control output to the current mirror.

14. The method of claim 9, where making a load current control decision comprises:
asserting a disable signal on a control output to a primary transistor in the current mirror through which the load current flows.

15. The method of claim 9, where determining further comprises:
receiving a sense current on the sense input provided by a mirror transistor in the current mirror.

16. The method of claim 15, where determining further comprises:
receiving a sense current on the sense input provided by a mirror transistor matched to a primary transistor through which the load current flows.

17. The method of claim 9, where determining further comprises:
receiving a sense current that is a predetermined ratio of the load current on the sense input; and
reading, with a network power controller, a mirror ratio that relates the sense current to the load current.

18. The method of claim 17, further comprising:
comparing, with the network power controller, the load current to a load current limit.

19. A system comprising:
an Ethernet RJ-45 network port comprising a transmit connection and a receive connection;
a current mirror connected to the network port and comprising:
a control input;
a load input configured to receive load current delivered through the network port;
a primary transistor through which the load current flows, the primary transistor connected to the control input and the load input;
a mirror transistor in communication with the primary transistor, the mirror transistor configured to generate a sense current on a reference output that is a preconfigured mirror ratio of the load current; and
a network power controller comprising:
a sense input in communication with the reference output;
a control output in communication with the control input; and
a memory configured to store:
the mirror ratio; and
control instructions configured to cause the network power controller to:
read the mirror ratio;
monitor the reference output to determine load current through the network connection; and
determine how to drive the control output depending on the load current.

20. The system of claim 19, where the control instructions are configured to cause the network power controller to:
read a load current limit from the memory;
assert a disable signal on the control output to the primary transistor in the current mirror through which the load current flows, when the load current exceeds the load current limit; and
assert an enable signal on the control output to the primary transistor in the current mirror through which the load current flows, when the load current does not exceed the load current limit.
